(19) United States
(12) Patent Application Publication
(10) Pub. No.: US 2017/0178269 A1
(43) Pub. Date: Jun. 22, 2017

(54) DISPLAYED IDENTIFIER FOR A RIDESHARING SERVICE

(71) Applicant: Counterfy LLC, Boston, MA (US)

(72) Inventors: Daniel J. McKinnon, Wayland, MA (US); Jennifer Erickson, Annapolis, MD (US)

(21) Appl. No.: 15/380,195

(22) Filed: Dec. 15, 2016

Related U.S. Application Data
(60) Provisional application No. 62/268,673, filed on Dec. 17, 2015.
(60) Provisional application No. 62/341,757, filed on May 26, 2016.

(51) Int. Cl. G06Q 50/30; H04W 4/04; G06Q 10/06

(52) U.S. Cl. CPC G06Q 50/30; G06Q 10/06311; H04W 4/046

(57) ABSTRACT

Techniques are described for determining an identifier (ID) that identifies a vehicle employed in a ridesharing service, presenting the ID through a presentation device of the vehicle, and communicating the ID to a passenger to help guide the passenger to the appropriate vehicle. The ID may be presented in a presentation device, such as a light-emitting diode (LED) display, that is temporarily or permanently affixed to the vehicle. The ID may also be communicated for presentation by a passenger device of the passenger. In some implementations, the ID is a particular color that is selected on the driver device of the driver of the vehicle, such that the presentation device displays the selected color. The presentation device may also present text data.

### CROSS-REFERENCE TO RELATED APPLICATIONS

The present disclosure is related to, and claims priority to, U.S. Provisional Patent Application Ser. No. 62/268,673, titled “Passenger Identifying Beacon for Ridesharing Vehicles,” which was filed on Dec. 17, 2015, and U.S. Provisional Patent Application Ser. No. 62/341,757, titled “Displayed Vehicle Identifier for a Ridesharing Service,” which was filed on May 26, 2016, both of which are hereby incorporated by reference into the present disclosure.

### BACKGROUND

Given the high cost of vehicle ownership and the increasing congestion of roadways, ridesharing services are becoming more popular. A user may employ a ridesharing service application executing on a mobile device to request a vehicle, submit a payment using a specified payment method, and rate the driver and/or rideshare experience. Given the growing popularity of ridesharing services and the increasing number of users and vehicles participating in ridesharing services, it may be difficult for a user to find the correct vehicle when it arrives to pick up the user.

### SUMMARY

Implementations of the present disclosure are generally directed to assisting a passenger to identify a vehicle of a ridesharing service, by presenting an identifier on a vehicle to help guide a passenger to the vehicle. More specifically, implementations are directed to determining an identifier through operations of an application executing on a driver's computing device, and displaying the identifier through a display device of the vehicle to help guide the passenger to the particular vehicle on which the identifier is displayed.

In general, innovative aspects of the subject matter described in this specification can be embodied in methods that include actions of: receiving a message indicating transport of a passenger; determining a selection of an identifier (ID) to be presented by a presentation device of the vehicle; transmitting the ID to the presentation device to instruct the presentation device to present the ID; and transmitting the ID for presentation by a passenger computing device of the passenger.

Implementations can optionally include one or more of the following features: the ID is a color; the presentation device further presents text data; the actions further include receiving a selection by the driver of at least a portion of the text data; the ID is presented by the passenger computing device during a period of time, prior to the transport of the passenger, when the ID is being presented by the presentation device of the vehicle; the ID is transmitted to the presentation device over a wireless network; the ID is transmitted to the presentation device over the wireless network using a version of Bluetooth wireless networking standard; the presentation device includes a light-emitting diode (LED) display; the presentation device is affixed to the vehicle; and/or the presentation device is temporarily affixed to the vehicle.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following advantages. By presenting an identifier that is particularly associated with a vehicle, a passenger, and/or a driver of the vehicle, and by communicating the vehicle identifier to the passenger, implementations help a passenger of a ridesharing service to quickly find the vehicle that is to transport the passenger to their destination. Traditional ridesharing services may rely on a license plate number and/or the make, model, and color of the vehicle to guide a passenger to the vehicle. However, it may be difficult for a passenger to distinguish among possible vehicles based on this information, given that many vehicles may resemble one another and given that different license plates may employ similar color and design schemes. By presenting a vehicle identifier that is sufficiently unique and readily recognizable (e.g., from a distance) among a large group of vehicles engaged in ridesharing services, implementations help a passenger to quickly find their assigned vehicle in a congested area, thus eliminating the delay, confusion, or missed rides that may occur otherwise. Accordingly, implementations provide an improvement over other traditional ridesharing services which may not provide an identifier to guide the passenger, and/or which may provide descriptive information that is not distinctive or unique enough to guide the passenger quickly and reliably to the vehicle.

Because implementations facilitate the rapid meeting of a passenger with their assigned vehicle, implementations provide a technical improvement over traditional solutions by reducing the wait time and fuel consumption of vehicles participating in ridesharing services, and by enabling the ridesharing service to handle more passengers more efficiently. Moreover, the passenger-guiding beacon may reduce the number of missed rides or delays within a ridesharing service by helping passengers to more reliably find their vehicles. Thus, implementations provide for a technical improvement over computing systems currently employed in ridesharing services, by reducing the consumption of processing capacity, network bandwidth, storage space, and/or memory resources that would otherwise result from the additional operations that traditional systems would need to perform in response to missed rides, delayed pickups, customer service calls, or other problems caused by the confusion of a passenger not finding the right vehicle.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for presenting a vehicle identifier on a rideshare vehicle and communicating the vehicle identifier to a passenger, according to implementations of the present disclosure.

FIG. 2 depicts an example system for presenting a vehicle identifier in a display of a rideshare vehicle, according to implementations of the present disclosure.

FIGS. 3A and 3B depict example user interfaces of a passenger application for a ridesharing service, according to implementations of the present disclosure.

FIGS. 4A and 4B depict example user interfaces of a driver application for a ridesharing service, according to implementations of the present disclosure.

FIG. 5 depicts a flow diagram of an example process for determining a vehicle identifier presented on a rideshare vehicle and communicating the vehicle identifier to a passenger, according to implementations of the present disclosure.

FIG. 6 depicts a flow diagram of an example process for presenting a vehicle identifier on a rideshare vehicle, according to implementations of the present disclosure.

FIG. 7 depicts an example computing system, according to implementations of the present disclosure.

### DETAILED DESCRIPTION

Implementations of the present disclosure are directed to systems, devices, methods, and computer-readable media for determining a vehicle identifier (ID) that is associated with a vehicle and/or driver employed in a ridesharing service, presenting the vehicle ID on the vehicle, and communicating the vehicle ID to a passenger. The vehicle ID may be presented in a decal, placard, and/or other object that is temporarily or permanently attached to the vehicle. Alternatively, the vehicle ID may be presented in a beacon (e.g., electronic display) of the vehicle. The vehicle ID associated with a particular vehicle may be communicated to a passenger device for presentation in a UI of the passenger device. The presentation of the vehicle ID on the vehicle may help guide the passenger to the particular vehicle that has arrived to pick up the passenger. For example, the passenger may look for the particular vehicle that displays the particular vehicle ID among a group of vehicles in proximity to the passenger's pickup location.

Using a traditional ridesharing service, a user may employ an application (e.g., a mobile application) to request a vehicle. A driver of a vehicle may indicate that they accept the fare, and may proceed to the passenger's location. However, when the vehicle arrives at the passenger's location for pickup, it may be difficult for the passenger to identify the particular vehicle that has arrived to transport the passenger. Although traditional ridesharing services may indicate the driver's name, vehicle make, model, and color, and license plate number to the passenger, such information may not be sufficiently unique to help the passenger readily identify the vehicle. For example, in a crowded area such as an airport passenger pickup lot or urban setting there may be many vehicles waiting to pick up different passengers, and a user of a traditional ridesharing service may need to examine the license plates of the various vehicles to find their ride. This may be difficult in a crowded environment, especially from a distance. Moreover, a passenger may not be able to readily distinguish a particular make, model, and/or color of a vehicle compared to other similar vehicles. A particular ridesharing service gives drivers the option to affix a particular object (e.g., a pink mustache) to their vehicle to indicate that the vehicle is part of the ridesharing service. However, this object still does not assist a passenger in identifying their particular vehicle among multiple vehicles that are also part of the same ridesharing service, given that the object is the same for each vehicle. Accordingly, although the systems currently employed by ridesharing services may provide some information to the passenger, the information provided still does not make it easy for a passenger to quickly and reliably find the correct vehicle, particularly when many other vehicles are present. By providing a system in which a unique and readily identifiable vehicle ID is displayed on a rideshare vehicle, implementations help passengers find their vehicles more quickly and reliably compared to traditional ridesharing systems, and thus provide a more positive user experience for both passengers and drivers.

As used herein, a ridesharing service may include any service through which any number of passengers are able to request a ride from one or more vehicles. The ridesharing service may provide rides in exchange for a fee per ride, fee per time, or fee per distance, such as a taxi service, car-for-hire service, limousine service, and so forth. A ridesharing service may also provide rides in exchange for a periodic (e.g., monthly) subscription free. In some examples, a ridesharing service may provide rides for free. A ridesharing service may provide vehicle(s) for individual passenger(s) to ride in alone, with a human driver or in an autonomous vehicle operated through artificial intelligence (AI) or remote control. In some instances, the ridesharing service may provide vehicle(s) that may transport multiple passengers at a time, with a human driver or in an autonomous vehicle operated through AI or remote control (e.g., teleoperation).

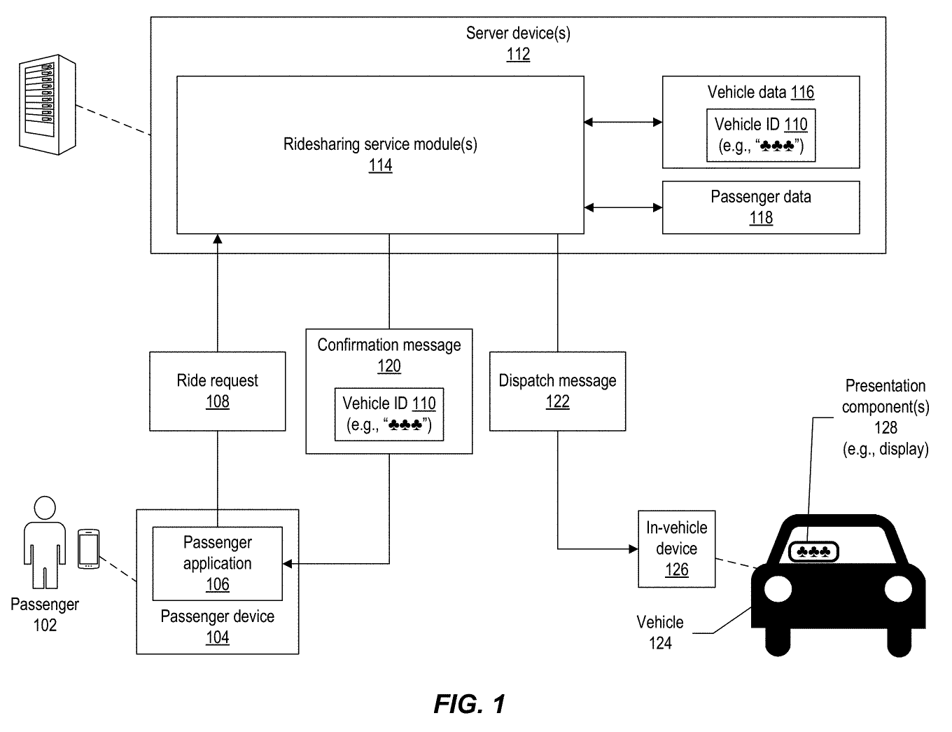

FIG. 1 depicts an example system for presenting a vehicle ID on a rideshare vehicle and communicating the vehicle ID to a passenger, according to implementations of the present disclosure. As shown in the example of FIG. 1, a system may include a passenger device 104 operated by, or otherwise associated with, a passenger 102. The passenger device 104 may include any type of computing device. In some examples, the passenger device 104 may be a mobile and/or portable device such as a smartphone, wearable computing device, tablet computer, and so forth. The passenger device 104 may execute a passenger application 106 configured to interact with a ridesharing service. The passenger 102 may use the passenger application 106 to generate and send a ride request 108. The ride request 108 may request a vehicle to pick up the passenger 102 at their current location or a specified location. The passenger 102 may also use the passenger application 106 to provide a payment through a specified payment method (e.g., payment card), track the approach of their assigned vehicle, rate their experience, and so forth.

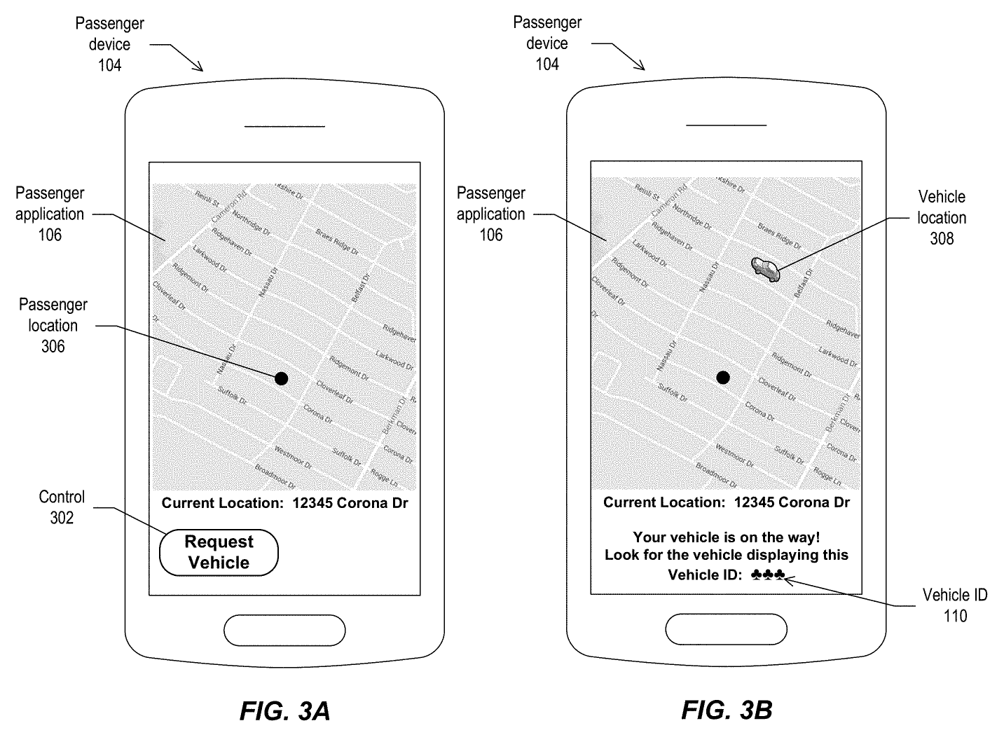

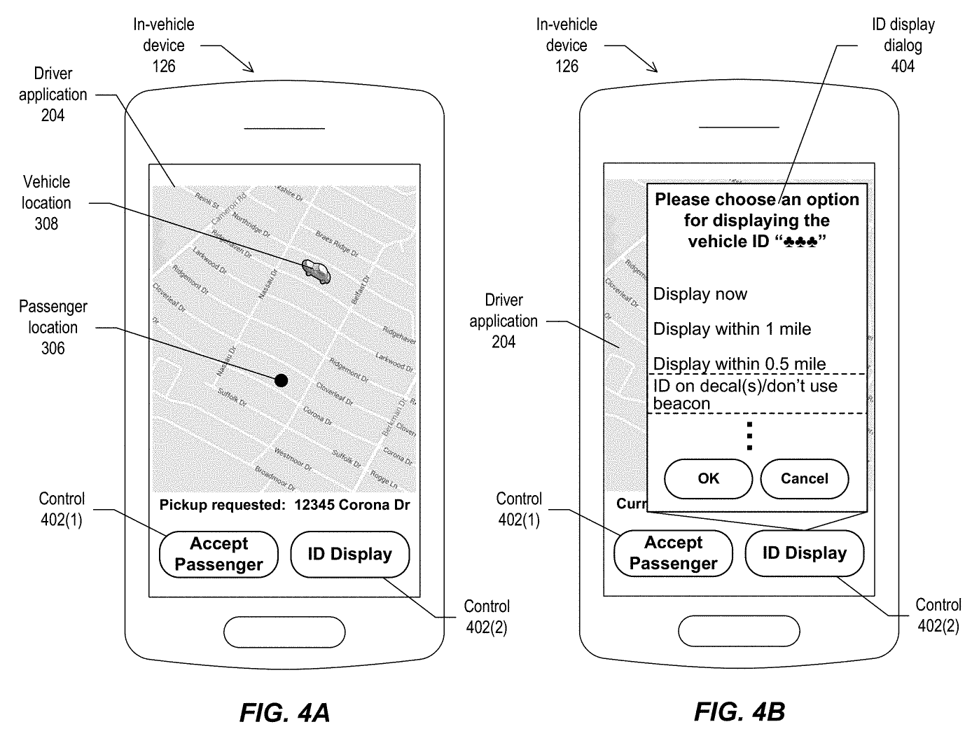

The system may include one or more server devices 112 that execute one or more ridesharing service modules 114. The server device(s) 112 may include any suitable type and number of computing device(s), such as server computers, distributed computing servers (e.g., cloud servers), and so forth. The ridesharing service module(s) 114 may be configured to perform various operations to provide a ridesharing service, including providing the information presented in the various UIs as shown in the example of FIGS. 3 and 4.

The passenger 102 may use the passenger application 106 to generate a ride request 108 and send the ride request over one or more networks to the ridesharing service module(s) 114. The ride request 108 may request a vehicle 124 to pick up the passenger 102 at the passenger's current location or at a pickup location designated by the passenger 102 in the passenger application 106. The ridesharing service module(s) 114 may process the ride request 108 and send a dispatch message 122 to one or more vehicles 124 that are currently participating in the ridesharing service, that are sufficiently close to pick up the passenger 102, and/or that may be available to pick up the passenger 102. In some implementations, the ridesharing service module(s) 114 may access vehicle data 116 stored on the server device(s) 112 or elsewhere. The vehicle data 116 may identify one or more vehicles 124 that are currently participating in the ridesharing service and/or available to transport passengers. The vehicle data 116 may also include a vehicle ID 110 for each of the vehicle(s) 124, as described further below. One or more dispatch messages 122 may be sent to the vehicle(s) 124 determined based on the vehicle data 116.

The dispatch message(s) 122 may be presented to driver(s) of the various vehicle(s) 124 through an in-vehicle device 126. The in-vehicle device 126 may include any type of computing device. In some examples, the in-vehicle device 126 may be a consumer device such as a smartphone, tablet computer, wearable computer, and so forth. The in-vehicle device 126 may also be an automotive computer and/or telematics device configured to provide various features associated with operating a vehicle. In some examples, the in-vehicle device 126 may be specifically configured to enable the driver to participate in the ridesharing service. For example, the in-vehicle device 126 may be provided by the ridesharing service. In some instances, the in-vehicle device 126 may be useable for a variety of purposes in addition to ridesharing service functionality.

The in-vehicle device 126 may execute a driver application including a user interface (UI) that enables the driver to participate in the ridesharing service. The driver application may present the dispatch message(s) 122 indicating potential passenger(s) that the driver may choose to transport. The driver application may enable a driver to accept a dispatch message 122 and trigger the sending of an acceptance message indicating that the driver has agreed to pick up and transport the passenger 102.

In response to receiving a driver's acceptance of the dispatch message 122, the ridesharing service module(s) 114 may generate and send a confirmation message 120 to the passenger device 104. The confirmation message 120 may be presented in the UI of the passenger application 106, and may indicate the particular vehicle 124 that is in route to pick up the passenger 102. The confirmation message 120 may identify the driver of the vehicle 124 and provide a description of the vehicle 124 (e.g., color, make, model, etc.), and/or a license plate or tag number of the vehicle 124. The confirmation message 120 may also provide an estimated time of arrival for the vehicle 124. The passenger application 106 may present a map showing the location and/or travel direction of the vehicle 124 as it approaches the pickup location. In addition to the color, make, model, and/or license plate/tag number of the vehicle 124, the confirmation message 120 may also include the vehicle ID 110 that is particularly associated with the vehicle 124. The vehicle ID 110 may be presented on the vehicle 124 through one or more presentation components 128, such as one or more decals, placards, displays, and so forth. The vehicle ID 110 may uniquely identify the vehicle 124 among multiple vehicles that may also be present at the pickup location, thus helping the passenger 102 find the vehicle 124.

In some implementations, the ridesharing service module(s) 114 may access passenger data 118 stored on the server device(s) 112 or elsewhere. The passenger data 118 may include, for one or more passengers, preference information for the passenger(s).

In some implementations, the ridesharing service module(s) 114 may access vehicle data 116 stored on the server device(s) 112 or elsewhere. The vehicle data 116 may include, for each of one or more vehicles 124 participating in the ridesharing service, a description of a vehicle 124 including the make, model, color, year, license plate or tag number, and/or other descriptive information. The vehicle data 116 may also include information describing the driver of the vehicle 124, such as the driver's first name, last name, first or last initial, a photograph of the driver, and so forth. In some implementations, the vehicle data 116 includes the vehicle ID 110 that is currently associated with the vehicle 124 and/or its driver. The vehicle ID 110 may include one or more types of data, including one or more of the following:

A name (or pseudonym) of the driver of the vehicle 124, a portion of the driver's name, and/or a nickname or pseudonym of the driver such as “Joe Smith,” “Joe S.,” “Smith,” “Joe,” “J. S.,” and/or other name-based identifiers;

One or more symbols, such as one or more of a shape, icon, emoji, hieroglyph, and/or other type of symbol;

One or more patterns, colors, shadings, and so forth;

One or more images, including still image(s) and/or video data;

Text data, including any number of characters and/or words expressed in any language or not corresponding to a language, the character(s) including letters, numbers, punctuation characters, and/or any other characters (e.g., in any character set such as a version of Unicode, ASCII, etc.); or

Any amount of audio data, including a selection of music of any length, any number of tones played at one or more pitches, a pattern of tones, words or phrases generated using any text-to-speech technique, and/or other audio data.

In some implementations, the vehicle ID 110 may include a combination of different types of information. For example, a vehicle ID 110 may include one or more particular symbol(s) having particular color(s) or patterns, the symbol(s) presented on a background that includes one or more patterns, colors, and/or images. The vehicle ID 110 may include a visual component as well as an audio component, such as a symbol of a particular color that is presented while a segment of music is played. In the example of FIG. 1, the vehicle ID 110 is a set of three “club” symbols.

One or more presentation components 128 may be present on and/or in the driver's vehicle 124, arranged to present the vehicle ID 110 to be visible to individuals outside the vehicle 124. In some implementations, the ridesharing service may provide the driver with one or more presentation components 128 to place in the driver's vehicle 124. The presentation component(s) 128 may present the vehicle ID 110 visually, audibly, and/or otherwise. For example, the presentation component(s) 128 may include one or more decals, placards, and/or other objects onto which the vehicle ID 110 has been printed or otherwise visibly applied. Such presentation component(s) 128 may be affixed (permanently or temporarily) to the inside or outside of the vehicle 124 such that the vehicle ID 110 is visible to passenger(s) outside the vehicle 124. In some examples, the presentation component(s) 128 may include multiple decals and/or placards which may be placed on different sides of the vehicle 124. For example, one presentation component 128 may face out from the windshield (front window) of the vehicle 124, and another presentation component 128 may face out from the rear window of the vehicle 124.

In some implementations, the presentation component(s) 128 may include a display (also referred to herein as a beacon) such as a light emitting diode (LED) display or other type of display. In such examples, the vehicle ID 110 may be communicated to and presented through the presentation component(s) 128, as described further below. The in-vehicle device 126 and/or driver application may also enable the driver to select one or more options for the presentation of the vehicle ID 110 through the presentation component(s) 128. Such option(s) may include size(s), color(s), font(s), blinking, flashing, scrolling, and/or other options for the presentation of at least a portion of the vehicle ID 110. In examples where the vehicle ID 110 includes audio data for presentation through the presentation component(s) 128, the driver may also specify options for volume, number of times to play the audio data, frequency of repeated plays of the audio data, and/or other options. In instances where the vehicle ID 110 includes text to be played as audio data, implementations may employ any type of text-to-speech (TTS) software to generate the audio data based on text data.

The driver ID 116 associated with a driver and/or their vehicle 124 may be stored in the vehicle data 116. In some implementations, the driver ID 116 may be stored on the in-vehicle device 126 instead of or in addition to being stored in the vehicle data 116 on the server device(s) 112 or elsewhere.

In some implementations, the driver may select their vehicle ID 110 when they initially register to participate in the ridesharing service. For example, through a registration user interface and/or other registration process, the driver may be presented with various options for their vehicle ID 110, and the driver may select among the options to indicate their vehicle ID 110. For example, a ridesharing service may require the driver to select one or more foreground symbols and a background (e.g., color, pattern, image, etc.), and the combination of the foreground symbol(s) and background may be presented as the vehicle ID 110. The driver may select among symbols such as one or more icons, images, emoji, characters, alphanumeric text, hieroglyphs, and so forth. The driver may select among backgrounds such as one or more monochrome backgrounds, backgrounds that are combinations of colors, patterned backgrounds, background images, background video, animated or graphical backgrounds, and so forth. In some instances, the registration system may check that the driver's selected vehicle ID 110 is unique among drivers participating in the ridesharing service, such that the vehicle ID 110 is not associated with multiple drivers and/or multiple vehicles. If the vehicle ID 110 is unique within the ridesharing service, or at least unique among vehicles and/or drivers that operate in a particular region (e.g., city, state, province, county, etc.), the system may store the vehicle ID 110 in the vehicle data 116 associated with the driver and their vehicle 124.

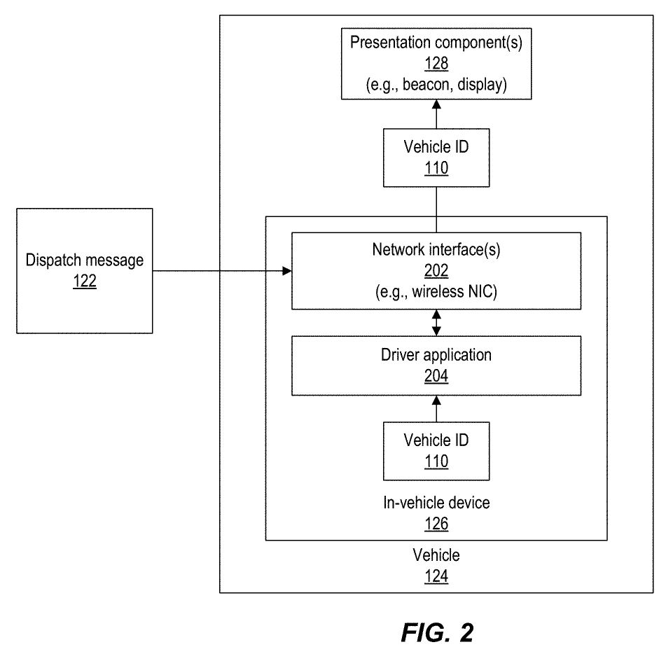

FIG. 2 depicts an example system including an in-vehicle device 126 configured to present a vehicle ID 110 through a presentation component 128 (e.g., display, beacon, etc.) of a rideshare vehicle 124, according to implementations of the present disclosure. As shown in the example of FIG. 2, the in vehicle device 126 may execute a driver application 204. The driver application 204 may interface with one or more network interfaces 202. The network interface(s) 202 may be network interface controller(s) (NIC(s)) and/or other types of transceiver(s) that enable the in-vehicle device 126 to communicate with other devices or processes over one or more networks (not shown). In some examples, the network interface(s) 202 may enable communications with the ridesharing service module(s) 114, or other remote service(s), over a wireless network such as a 3G network, 4G network, a long-term evolution (LTE) network, or any other type of wireless network.

The dispatch message 122, and/or other communications from the ridesharing service module(s) 114, may be received through the network interface(s) 202 and accessed by the driver application 204. The driver application 204 may enable the driver to view and/or accept dispatch message(s) 122, e.g., to accept passenger(s). The driver application 204 may generate a response message indicating acceptance of a passenger 102 identified in the dispatch message 122. The driver application 204 may instruct or otherwise cause the network interface(s) 202 to send the response message to the ridesharing service module(s) 114. In some implementations, the driver application 204 may retrieve the vehicle ID 110 from local storage on the in-vehicle device 126. Alternatively, the vehicle ID 110 may be communicated to the in-vehicle device 126 in the dispatch message(s) 122 and/or other communications. The driver application 204 may cause the vehicle ID 110 to be presented through the presentation component 128 such as a LED display attached to the vehicle 124. In some implementations, the driver application 204 may employ a wired or wireless network to send the vehicle ID 110 to the presentation component 128. For example, the driver application 204 may communicate with the presentation component 128 using a (e.g., short distance) wireless network that supports a version of the Bluetooth™ wireless networking standard.

In some implementations, the vehicle ID 110 may include (e.g., as metadata) one or more options for presentation of the vehicle ID 110 through the presentation component 128, such as options for color, font, volume, repetition, frequency, text size, and so forth. Alternatively, the driver may set such option(s) through the UI of the driver application 204. The vehicle ID 110 may be presented through the presentation component(s) 128 according to the specified options. In some examples, the driver application 204 may instruct the presentation component(s) 128 to present the vehicle ID 110 immediately upon receiving an indication that the driver has confirmed that they will transport the passenger 102. In some examples, the driver application 204 may instruct the presentation component(s) 128 to present the vehicle ID 110 when the vehicle 124 is within a threshold distance from the pickup location, such as one mile away, 100 yards away, and so forth. In some implementations, the driver application 204 may instruct the presentation component(s) 128 to discontinue presenting the vehicle ID 110 when the passenger 102 has been picked up.

In some implementations, the presentation component(s) 128 may include any number and any type of display. For example, the presentation component(s) 128 may include a LED display. In some examples, at least an externally visible portion of the presentation component(s) 128 may be located inside the windshield of the vehicle 124 (e.g., resting on the dashboard), with the displayed vehicle ID 110 facing outwards to be visible from outside the vehicle 124. Implementations also support the placement of the presentation component(s) 128 elsewhere on and/or in the vehicle 124, such as on the roof, on the hood, on the front bumper, and so forth. In some implementations, a vehicle 124 may include multiple presentation components 128 that present the same vehicle ID 110. For example, presentation components 128 may be placed on either side of the vehicle 124, on the roof of the vehicle 124, on the front of the vehicle 124, and/or on the rear of the vehicle 124. The presentation component(s) 128 may also include any number and type of audio output devices, such as speakers, placed anywhere on the vehicle 124. The one or more components of the presentation component(s) 128 may be affixed to any portion(s) of the vehicle 124. In some examples, the component(s) of the presentation component(s) 128 may be permanently attached to the vehicle 124. Alternatively, the component(s) of the presentation component(s) 128 may be temporarily attached to the vehicle 124 such that the presentation component(s) 128 may be removed from, and re-attached to, the vehicle 124 as needed. In some examples, the component(s) of the presentation component(s) 128 may rest on surfaces of the vehicle 124 without being temporarily or permanently attached. In some examples, the type, size, shape, and/or other configuration of the presentation component(s) 128 and/or the location(s) where it is attached to the vehicle 124 may comply with relevant laws, regulations, and/or rules governing the use of decals, placards, displays, speakers, and/or other types of presentation component(s) on vehicles.

Although examples herein may describe or depict the vehicle 124 as an automobile, implementations are not so limited. Implementations support any type of vehicle 124, including but not limited to an automobile (e.g., car), truck, bus, van, limousine, pedicab, hansom cab, boat, aircraft, and so forth.

FIGS. 3A and 3B depict example UIs of a passenger application 106 for a ridesharing service, according to implementations of the present disclosure. As shown in the example of FIG. 3A, the passenger application 106 may execute on the passenger device 104. The passenger application 106 may present a UI including a map of the area and the current passenger location 306. The passenger application 106 may include a control 302 to enable the passenger 102 to request a ride, with a pickup location at the current passenger location or some other pickup location specified by the passenger 102. Selection of the control 302 may cause the passenger application 106 to generate and send the ride request 108 as described above.

The ridesharing service module(s) 114 may receive the ride request 108 and send dispatch message(s) 122 to one or more in-vehicle devices 126. If a driver accepts the dispatch message 122, indicating that they will pick up the passenger 102 using the driver's vehicle 124, the ridesharing service module(s) 114 may send the confirmation message 120 to the passenger device 104. The ridesharing service module(s) 114 may retrieve the vehicle ID 110 from the vehicle data 116 for the vehicle 124, and include the vehicle ID 110 in the confirmation message 120.

The confirmation message 120 may be received at the passenger device 104, and information from the confirmation message 120 may be presented in the UI of the passenger application 106. As shown in the example of FIG. 3B, the passenger application 106 may present the vehicle ID 110 to enable the passenger 102 to look for the vehicle 124 that is presenting that particular vehicle ID 110. The passenger application 106 may also present other information included in the confirmation message 120, such as the name of the driver, the make, model, and color of the vehicle 124, the license plate and/or tag number of the vehicle 124, and so forth. The passenger application 106 may also present the current vehicle location 308 in the map view, to enable the passenger 102 to view the progress of the vehicle 124 as it approaches the pickup location.

FIGS. 4A and 4B depict example UIs of a driver application 204 for a ridesharing service, according to implementations of the present disclosure. As shown in the example of FIG. 4A, the driver application 204 may present a UI including a map of the area, the current vehicle location 308 of the vehicle 124, and the passenger location 306 (e.g., the current location of the passenger 102 or the specified pickup location). The driver application 204 may include a control 402(1) to enable the driver to accept a passenger by responding to a dispatch message 122. In some implementations, the driver application 204 may also include a control 402(2) to enable the driver to specify option(s) for presenting the vehicle ID 110 through the presentation component(s) 128, e.g., in instances where the presentation component(s) 128 include display(s).

As shown in the example of FIG. 4B, selecting the control 402(2) may cause the driver application 204 to present an ID display dialog 404. The ID display dialog 404 may include one or more lists, menus, buttons, or other UI elements that enable the driver to select a timing option for presenting the vehicle ID 110 through the presentation component(s) 128. For example, the ID display dialog 404 may enable the driver to indicate that the vehicle ID 110 is to be presented now (e.g., immediately upon the driver's acceptance of the passenger 102) in one or more beacons or displays. The ID display dialog 404 may also enable the driver to indicate a threshold distance from the pickup location at which the vehicle ID 110 will be presented. For example, the driver may indicate that the vehicle ID 110 is to be presented when the vehicle 124 is within 1 mile of the pickup location, within 0.5 miles of the pickup location, within 100 yards of the pickup location, or other threshold distance(s). Based on such a selection, the driver application 204 may instruct the presentation component(s) 128 to present the vehicle ID 110 when the determined distance of the vehicle 124 is within the specified threshold distance of the pickup location.

In some implementations, the ID display dialog 404 may enable the driver to indicate that the vehicle ID 110 is not to be presented in display(s), such as in instances where the driver is using decal(s), placard(s), and/or other object(s) to present the vehicle ID 110. In some instances, the vehicle ID 110 may be presented in electronic display(s) as well as on decal(s), placard(s), or other object(s). In some examples, the driver may use decal(s), placard(s), and/or other object(s) but may also use display(s) to ensure that the passenger 102 can see the vehicle ID 110. For example, if the driver is using a decal or placard that is not lit, the driver may also choose to present the vehicle ID 110 through display(s) at nighttime, if it is raining, or in other situations when the passenger 102 may not be able to easily see the decal or placard. In some implementations, the driver application 204 may dynamically determine to present the vehicle ID 110 in one or more displays based on the time of day (e.g., nighttime), based on detecting ambient light conditions, and/or based on other detected environmental conditions.

Implementations support various techniques for determining the locations of the vehicle 214, the in-vehicle device 126, and/or the passenger device 104, and distances between vehicles and/or devices. For example, one or more of these devices may include transceivers that detect signals from satellite-based navigation systems such as the Global Positioning System (GPS). Based on the received signal(s), the current location of a device may be determined, and a distance between the current location and the pickup location may also be determined.

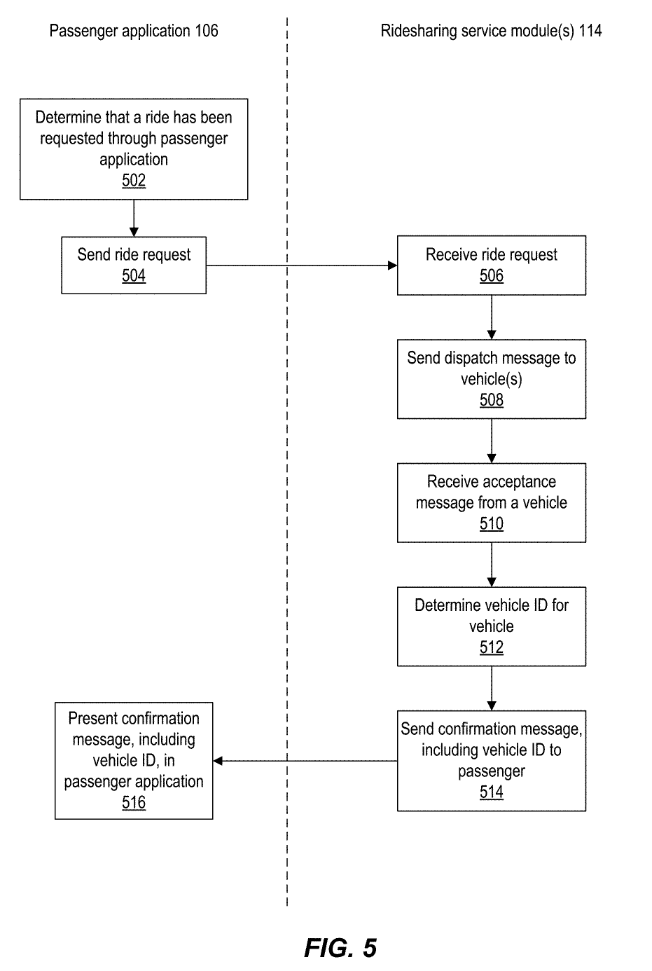

FIG. 5 depicts a flow diagram of an example process for determining a vehicle ID 110 to be presented on a rideshare vehicle 124 and communicating the vehicle ID 110 to the passenger 102, according to implementations of the present disclosure. Operations of the process may be performed by one or more of the passenger application 106, the ridesharing service module(s) 114, the driver application 204, or other software module(s) executing on the passenger device 104, the server device(s) 112, the in-vehicle device 126, or elsewhere.

The passenger application 106 may determine (502) that a ride has been requested by a passenger 102 through the UI of the passenger application 106. A ride request 108 may be sent (504) in response to determining that a ride is requested.

The ridesharing service module(s) 114 may receive (506) the ride request 108. A vehicle 124 may be determined for transporting the passenger 102 identified in the ride request 108. This determination may include sending (508) dispatch messages 122 to one or more vehicles 124 that are currently participating in the ridesharing service. On receiving (510) an acceptance message from one of the vehicles 124, a vehicle ID 110 is determined (512) that corresponds to the accepting vehicle 124. In some implementations, the vehicle ID 110 is determined by retrieving the vehicle ID 110 from the vehicle data 116 corresponding to the vehicle 124.

A confirmation message 120 may be sent (514) to the passenger device 104. The confirmation message 120 may include the vehicle ID 110 corresponding to the vehicle 124. The confirmation message 120 may be received at the passenger device 104 and at least a portion of the confirmation message 120 may be presented (516) in the UI of the passenger application 106, to inform the passenger 102 that their ride is on the way. The vehicle ID 110 may be extracted from the confirmation message 120 and presented in the UI to help the passenger 102 find the vehicle 124.

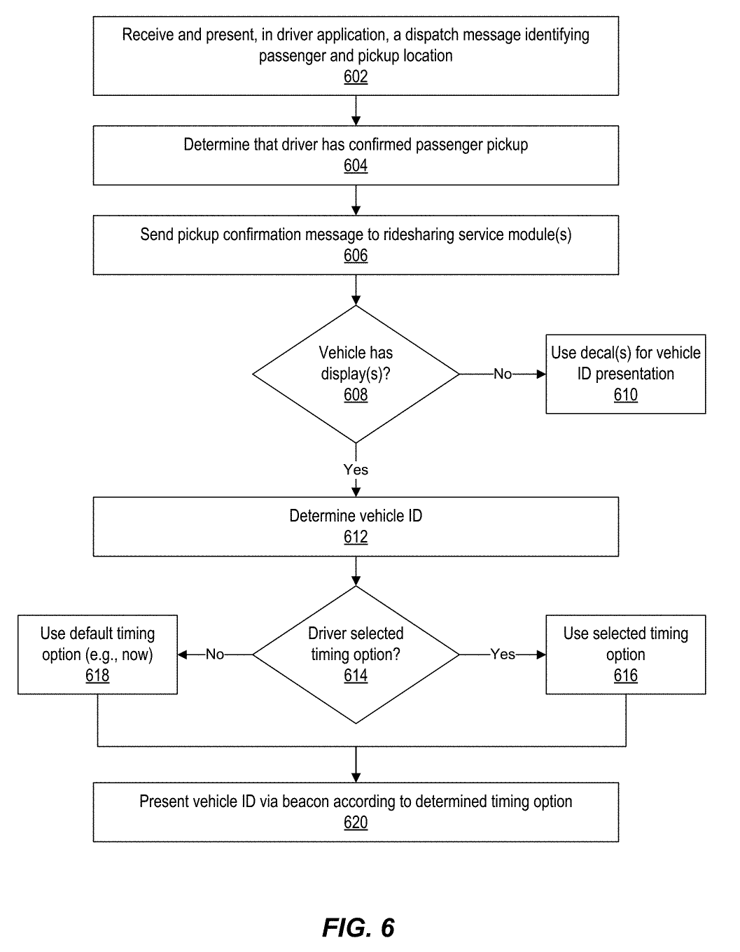

FIG. 6 depicts a flow diagram of an example process for presenting a vehicle ID 110 on a rideshare vehicle 124, according to implementations of the present disclosure. Operations of the process may be performed by one or more of the passenger application 106, the ridesharing service module(s) 114, the driver application 204, or other software module(s) executing on the passenger device 104, the server device(s) 112, the in-vehicle device 126, or elsewhere.

A dispatch message 122 may be received and presented (602) in the driver application 204 executing on the in-vehicle device 126. In some examples, the dispatch message 122 may identify the possible passenger 102 and/or the pickup location for the passenger 102. The driver application 204 may detect or otherwise determine (604) that the driver has confirmed that their vehicle 124 will pick up and transport the passenger 102 (e.g., the driver accepts the fare). A pickup confirmation message (e.g., fare acceptance message) may be sent (606) to the ridesharing service module(s) 114.

A determination may be made (608) whether the driver's vehicle 124 includes one or more electronic displays through which the vehicle ID 110 may be presented. If not, then decal(s), placard(s), and/or other (e.g., static) physical object(s) may be used (610) for presenting the vehicle ID 110. In instances where the vehicle 124 includes display(s), such display(s) may be used in addition to or instead of the decal(s), placard(s), and/or other object(s) for presenting the vehicle ID 110.

If display(s) are available on the vehicle 124, the process may determine (612) the vehicle ID 110 corresponding to the vehicle 124 and/or its driver. In some implementations, such determination may include retrieving the vehicle ID 110 from local storage on the in-vehicle device 126. In some implementations, the vehicle ID 110 may be retrieved from the vehicle data 116 and communicated to the in-vehicle device 124 in a dispatch message 122 or other communication.

A determination may be made (614) whether the driver has selected a timing option for presentation of the vehicle ID 110. If so, the selected timing option may be used (616), such as the timing option selected through the ID display dialog 404, and the process may proceed to 620. If the driver has not selected a timing option, a default timing option may be used (618). The default timing option may be to begin presenting the vehicle ID 110 now and/or immediately upon the driver confirming that they will pick up the passenger 102. In some examples, the default option may be to not present the vehicle ID 110 through one or more displays and instead use the decal(s), placard(s), and/or other object(s) to present the vehicle ID 110.

If the vehicle ID 110 is to be presented through one or more displays, the driver application 204 may instruct the displays to present (620) the vehicle ID 110 according to the determined timing option. In some implementations, the presentation of the vehicle ID 110 in one or more displays may be discontinued after the passenger 102 has been picked up. For example, the driver application 204 may include a control to enable the driver to indicate that the passenger 102 has been picked up. Selection of the control may cause the driver application 204 to send a signal to the display(s) to indicate that presentation of the vehicle ID 110 is to be discontinued.

In some implementations, the presentation component(s) 128 may present the vehicle ID 110 in addition to other information to further assist the passenger 102 in identifying the correct vehicle 124. For example, the presentation component(s) 128 may present the vehicle ID 110 as well as a passenger ID that uniquely identifies the passenger 102 among a population of users of the ridesharing service. The passenger ID may include various types of information such as symbols, icons, emoji, shapes, colors, patterns, images, video, audio, text, at least a portion of the passenger's name, and so forth. The passenger ID may also include any appropriate combination of these and/or other types of information. In some implementations, the passenger 102 may specify their passenger ID through the passenger application 106, and the passenger ID may be communicated to the ridesharing service module(s) 114. The passenger ID may be stored in the passenger data 118 associated with the passenger 102. The passenger ID may be communicated to the vehicle 124 in the dispatch message 122, and the passenger ID may be presented through the presentation component(s) 128 in addition to the vehicle ID 110, e.g., in examples where the presentation component(s) 128 include one or more displays. In some examples, the information presented through the presentation component(s) 128 may be a combination of elements associated with the driver and the passenger 102. For example, the presentation component(s) 128 may present a symbol over a background, where the symbol is associated with the driver (e.g., is included in the vehicle ID 110) and the background (e.g., color, image, etc.) is associated with the passenger 102 (e.g., is included in the passenger ID). As another example, the presentation component(s) 128 may present text element(s) over a background, where the text element(s) include at least a portion of the name of the passenger 102 (e.g., first name and last initial) and the background (e.g., color, image, etc.) is associated with the driver.

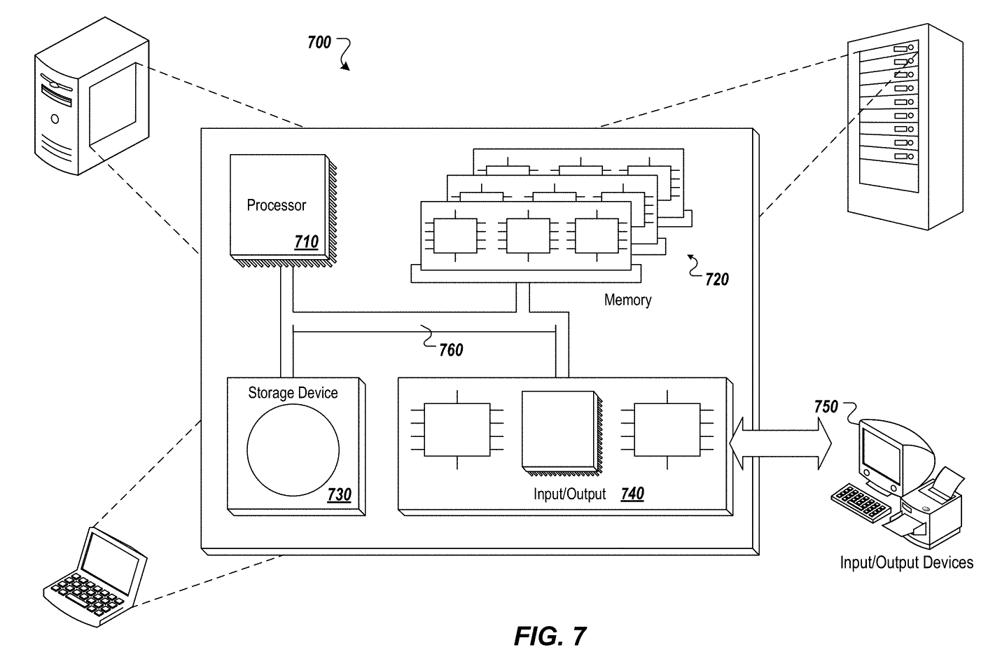

FIG. 7 depicts an example computing system, according to implementations of the present disclosure. The system 700 may be used for any of the operations described with respect to the various implementations discussed herein. For example, the system 700 may be included, at least in part, in one or more of the passenger device 104, the server device(s) 112, or the in-vehicle device 126 described herein. The system 700 may include one or more processors 710, a memory 720, one or more storage devices 730, and one or more input/output (I/O) devices 750 controllable through one or more I/O interfaces 740. The various components 710, 720, 730, 740, or 750 may be interconnected through at least one system bus 760, which may enable the transfer of data between the various modules and components of the system 700.

The processor(s) 710 may be configured to process instructions for execution within the system 700. The processor(s) 710 may include single-threaded processor(s), multi-threaded processor(s), or both. The processor(s) 710 may be configured to process instructions stored in the memory 720 or on the storage device(s) 730. The processor(s) 710 may include hardware-based processor(s) each including one or more cores. The processor(s) 710 may include general purpose processor(s), special purpose processor(s), or both.

The memory 720 may store information within the system 700. In some implementations, the memory 720 includes one or more computer-readable media. The memory 720 may include any number of volatile memory units, any number of non-volatile memory units, or both volatile and non-volatile memory units. The memory 720 may include read-only memory, random access memory, or both. In some examples, the memory 720 may be employed as active or physical memory by one or more executing software modules.

The storage device(s) 730 may be configured to provide (e.g., persistent) mass storage for the system 700. In some implementations, the storage device(s) 730 may include one or more computer-readable media. For example, the storage device(s) 730 may include a floppy disk device, a hard disk device, an optical disk device, or a tape device. The storage device(s) 730 may include read-only memory, random access memory, or both. The storage device(s) 730 may include one or more of an internal hard drive, an external hard drive, or a removable drive.

One or both of the memory 720 or the storage device(s) 730 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 700. In some implementations, the CRSM may include a data store that provides storage of computer-readable instructions or other information in a non-transitory format. The CRSM may be incorporated into the system 700 or may be external with respect to the system 700. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 710 and the memory 720 may be supplemented by, or incorporated into, one or more application-specific integrated circuits (ASICs).

The system 700 may include one or more I/O devices 750. The I/O device(s) 750 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 750 may also include one or more output devices such as a display, LED(s), an audio output device (e.g., a speaker), a printer, a haptic output device, and so forth. The I/O device(s) 750 may be physically incorporated in one or more computing devices of the system 700, or may be external with respect to one or more computing devices of the system 700.

The system 700 may include one or more I/O interfaces 740 to enable components or modules of the system 700 to control, interface with, or otherwise communicate with the I/O device(s) 750. The I/O interface(s) 740 may enable information to be transferred in or out of the system 700, or between components of the system 700, through serial communication, parallel communication, or other types of communication. For example, the I/O interface(s) 740 may comply with a version of the RS-232 standard for serial ports, or with a version of the IEEE 1284 standard for parallel ports. As another example, the I/O interface(s) 740 may be configured to provide a connection over Universal Serial Bus (USB) or Ethernet. In some examples, the I/O interface(s) 740 may be configured to provide a serial connection that is compliant with a version of the IEEE 1394 standard.

The I/O interface(s) 740 may also include one or more network interfaces, such as the network interface(s) 202, that enable communications between computing devices in the system 700, or between the system 700 and other network-connected computing systems. The network interface(s) may include one or more network interface controllers (NICs) or other types of transceiver devices configured to send and receive communications over one or more networks using any network protocol.

Computing devices of the system 700 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 700 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical UI or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for identifying a vehicle of a ridesharing service, the method performed by a driver computing device of a driver of the vehicle, the method comprising:
receiving, by the driver computing device, a message indicating transport of a passenger;
determining, by the driver computing device, a selection of a vehicle identifier (ID) to be presented by a presentation device of the vehicle, wherein the selection of the vehicle ID is made by the driver through the driver computing device;
transmitting, by the driver computing device, the vehicle ID to the presentation device to instruct the presentation device to present the vehicle ID; and
transmitting, by the driver computing device, the vehicle ID for presentation by a passenger computing device of the passenger.

2. The method of claim 1, wherein the vehicle ID is a color.

3. The method of claim 1, wherein the presentation device further presents text data.

4. The method of claim 3, further comprising:
receiving, by the driver computing device, a selection by the driver of at least a portion of the text data.

5. The method of claim 1, wherein the vehicle ID is presented by the passenger computing device during a period of time, prior to the transport of the passenger, when the vehicle ID is being presented by the presentation device of the vehicle.

6. The method of claim 1, wherein the vehicle ID is transmitted to the presentation device over a wireless network.

7. The method of claim 6, wherein the vehicle ID is transmitted to the presentation device over the wireless network using a version of Bluetooth wireless networking standard.

8. A system for identifying a vehicle of a ridesharing service, the system comprising:
a driver computing device of a driver of the vehicle, the driver computing device including at least one processor and a memory communicatively coupled to the at least one processor, the memory storing instructions which, when executed by the at least one processor, cause the at least one processor to perform operations comprising:
receiving a message indicating transport of a passenger;
determining a selection of a vehicle identifier (ID) to be presented by a presentation device of the vehicle, wherein the selection of the vehicle ID is made by the driver through the driver computing device;
transmitting the vehicle ID to the presentation device to instruct the presentation device to present the vehicle ID; and
transmitting the vehicle ID for presentation by a passenger computing device of the passenger.

9. The system of claim 8, wherein the presentation device includes a light-emitting diode (LED) display.

10. The system of claim 8, wherein the presentation device is affixed to the vehicle.

11. The system of claim 10, wherein the presentation device is temporarily affixed to the vehicle.

12. The system of claim 8, wherein the vehicle ID is a color.

13. The system of claim 8, wherein the presentation device further presents text data.

14. The system of claim 13, the operations further comprising:
receiving a selection by the driver of at least a portion of the text data.

15. The system of claim 8, wherein the vehicle ID is presented by the passenger computing device during a period of time, prior to the transport of the passenger, when the vehicle ID is being presented by the presentation device of the vehicle.

16. One or more computer-readable media storing instructions for identifying a vehicle of a ridesharing service, the instructions which, when executed, cause a driver computing device of a driver of the vehicle to perform operations comprising:
receiving a message indicating transport of a passenger;
determining a selection of a vehicle identifier (ID) to be presented by a presentation device of the vehicle, wherein the selection of the vehicle ID is made by the driver through the driver computing device;
transmitting the vehicle ID to the presentation device to instruct the presentation device to present the ID; and
transmitting the vehicle ID for presentation by a passenger computing device of the passenger.

17. The one or more computer-readable media of claim 16, wherein the vehicle ID is a color.

18. The one or more computer-readable media of claim 16, wherein the presentation device further presents text data.

19. The one or more computer-readable media of claim 18, the operations further comprising:
receiving a selection by the driver of at least a portion of the text data.

20. The one or more computer-readable media of claim 16, wherein the vehicle ID is presented by the passenger computing device during a period of time, prior to the transport of the passenger, when the vehicle ID is being presented by the presentation device of the vehicle.
